(19) United States
(12) Patent Application Publication
(10) Pub. No.: US 2007/0224577 A1
(43) Pub. Date: Sep. 27, 2007

(54) Method and material for the production of tooth restorations of tooth replacement parts

(75) Inventors: Anton Bodenmiller, Luetkirchen (DE); Amit Paranjape, Bad Waldsee (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Kaltenbach & Voigt GmbH, Biberach (DE)

(21) Appl. No.: 11/702,962

(22) Filed: Feb. 6, 2007

(30) Foreign Application Priority Data
Feb. 9, 2006 (DE) 10 2006 006 081.4

(51) Int. Cl. A61C 5/10; A61C 5/08

(52) U.S. Cl. 433/223; 433/222.1

(57) ABSTRACT

In a method for the production of tooth restorations or tooth replacement parts from a non-metallic, inorganic material firstly a modelable material is modeled in plastic form in the mouth of a patient or with use of a model to a shaped part. The molding is then taken from the mouth of the patient or removed from the model and hardened to a ceramic tooth restoration or a tooth replacement part.

### BACKGROUND OF THE INVENTION

1. Field of the Invention

The invention relates to a method and material for the production of tooth restorations or tooth replacement parts of a biocompatible material.

2. Related Technology

The production of tooth replacement parts maintains a central role in dental medicine. The first individual porcelain teeth were produced in France as early as the year 1808. The development of the so-called ceramic jacket crown, which forms the basis for today's metal-facing ceramic, then occurred around 1900. Solid ceramic for individual crowns, inlays, onlays and veneers were then used in dental technology as metal-free alternatives from 1982.

The most important criteria for use of new materials for the production of tooth restorations or tooth replacement parts are, as before, a suitable biocompatibility as well as the aesthetic effect achievable with the material. With the introduction of modern high performance oxide ceramics and, in particular, tempered glass ceramics a wide spectrum of working materials stands at the disposal of dentistry today, to provide the patient with ceramic tooth replacements which are biocompatible, aesthetic, and long-lasting. A prerequisite for this is, however, a procedure which is consistently throughout adapted exactly to the ceramic material. This starts with a preparation of the tooth which is appropriate for the ceramic, a construction adapted to the ceramic material, production and facing in the dental laboratory, and an attachment corresponding to the situation of the patient with composites or cementing in the patient mouth.

Depending on the indication, the most widely differing ceramic systems are currently put to use. For the production of onlays, inlays, and front tooth crowns, for example, leucite (KAlSi₂O₆) reinforced glass ceramics are put to use as pressable ceramics. Further, such leucite reinforced glass ceramics also are employed as millable ceramics with the use of CAD/CAM systems. A system alternative to this is the use of framework cores consisting of Al₂O₃ or ZrO₂ and a suitable facing. This combination is used for the production of front tooth crowns, side tooth crowns, or molar tooth crowns, for example. Related to this are bridge frameworks of ZrO₂ with suitable facing, which are used for the production of bridges in the front tooth area, bridges in the side tooth area, and broad span molar tooth bridges. Finally, ZrO₂ ceramics are employed with a corresponding facing also for the production of so-called implant abutments or implant superstructures.

In recent times there are also available, primarily for molar tooth crowns, completely new materials which make it possible to produce crowns, inclusive of chewing surfaces, of ceramics, without additional facing. This is made possible in that the material put to use for this, e.g. a zirconium/silicate ceramic, does not shrink during sintering.

In every case ceramic inlays, onlays, veneers, front tooth crowns, side tooth crowns, and molar tooth crowns require as highly biocompatible patient treatment a complex and expensive technical production, drawing on specialists. This is independent of whether the tooth replacement parts are produced in the dentist's practice itself, produced by the dental laboratory, or manufactured by an industrial mass producer. At the dentist's office, CAD/CAM milling systems are preferably put to use in connection with an intra-oral camera. In the dental laboratory, in turn, production with pressable ceramics, similar to metal casting technology, stands in the foreground. Also, CAD/CAM milling/grinding production and so-called slip production are used in the dental laboratory. Similar manufacturing methods finally are also put to use in industrial mass production, whereby however in the use of pressable ceramics the production is carried out in a highly automated manner. Also with the use of other techniques semi or fully automatic machines are preferably used.

At present, highly biocompatible tooth replacements, as in principle would be desirable for medical reasons, are still produced in the way described before. Due to the production technology, the related production times and the material use, a completely biocompatible, ceramic tooth replacement is, however, still very expensive for the patient, for which reason the use of such ceramic replacement parts is not yet standard treatment. Instead, for the main application fields of dentistry, namely the filling of tooth defects, although there are employed more price favorable materials, with amalgam—which is however only seldom used—and plastics, these are not highly biocompatible and beyond this are limited in their durability.

### SUMMARY OF THE INVENTION

In view of the extremely high number of patient treatments needed every year worldwide, correspondingly the invention provides a method and a material which make possible the economical production of a high quality tooth replacement part.

Accordingly, the invention provides a method for the production of tooth restorations or tooth replacement parts from a non-metallic, inorganic material, comprising the steps of:

a) modeling a modelable material in plastic form in the mouth of a patient or with use of a model to form a shaped part,

b) removing the shaped part from the mouth of the patient or from the model, and

c) hardening the shaped part to a ceramic tooth restoration or to a tooth replacement part.

The invention also provides a non-metallic, inorganic material for the production of tooth restorations or tooth replacement part materials for the production of tooth restorations or tooth replacement parts, comprising

a ceramic component which makes possible a hardening of the material to a ceramic part, and

a binder which places the material in a plasticized state.

### BRIEF DESCRIPTION OF THE DRAWINGS

Below, the method according to the invention for the production of tooth restorations or tooth replacement parts will be explained in more detail with reference to the accompanying drawings. There is shown:

FIG. 1—the steps of a first method according to the invention for the production of a tooth replacement part; and,

FIG. 2—the steps of a manufacturing method alternative to this in accordance with the present invention.

### DETAILED DESCRIPTION

The solution according to the invention is based on the idea of using a modelable, non-metallic inorganic mass which permits itself to be introduced in the plasticized state into the cavity or other treatment measures. In the mouth of the patient or alternatively to this also in the model of the dental technician this material then can be modeled with suitable instruments, i.e. to the occlusal condition, and thereby formed into a shaped part with suitable contours. After this forming the modeled part then can be again removed from the patient mouth or the model, in order then to harden it in a thermal process to a biocompatible, ceramic, prosthetic provision. For this purpose it is preferably provided that already before the removal of the part from the patient mouth or the model this is pre-hardened to ensure that the part is not deformed upon removal. In this way there is made possible a simple production of a tooth restoration or a tooth replacement part which meets the highest requirements both with regard to its biocompatible characteristics and with regard to its shape accuracy.

Thus there is proposed according to the invention a method for the production of tooth restorations or tooth replacement parts of a non-metallic, inorganic material in which firstly a modelable material in plastic form is modeled to a shaped part in the mouth of a patient or under use of a model, then the shaped part is removed from the mouth of the patient or removed from the model and is in conclusion hardened to a ceramic replacement part. Preferably the modeled shaped part is pre-hardened before removal from the mouth of the patient or the removal from the model.

For the method according to the invention it is advantageous to use materials as are recently known for production in CAD/CAM systems. Particularly the use of zirconium/silicate ceramics is appropriate, which have the characteristic that they shrink only slightly, or do not shrink at all, during the thermal treatment process. To date these materials have been worked predominantly in a solid state, for which complex and expensive machines were required. With the use of a modelable mass in accordance with the method according to the invention it is possible, however, to carry out the design of the tooth restoration or the tooth replacement part by conventional, simple or manual modelling, for which reason then only a suitable, for example thermal method for the completion of the ceramic tooth replacement is required.

It can make sense, depending on the indication, for example inlay or crown, to adapt the shrinkage behavior of the material put to use according to the invention. For example a freedom from shrinkage is desirable in the production of inlays which are emplaced adhesively, while in contrast a certain volume shrinkage is definitely of advantage in the cementing in of crowns, to be able to take into account the cement gap. This desired shrinkage can be taken into account with the method according to the invention by use of a suitable material.

The pre-hardening of the plasticized mass in the patient mouth or in the model can be effected by different measures. For example the addition of binders which are hardenable, similarly to today's plastic filler materials, by means of light would be conceivable. There would also be possible the use of multiple component systems which time-dependently become increasingly hard and have a sufficient stability at the time of the removal of the shaped part. Also other technical solutions, such as laser hardening, chemical treatment or similar methods finally could be used.

The hardening or sintering of the shaped part outside the patient mouth or the model can then be effected in a suitable way analogously to today's sinter method for ceramic materials in a sintering oven. Beyond this, with use of a suitable material for the model, hardening in the model itself would also be conceivable. Depending on material specification the use of a commercially conventional ceramic kiln is, however, also conceivable. Also the use of other methods, for example use of microwaves or laser radiation for the hardening, would be possible.

An advantage of the method according to the invention lies on the one hand in an up to now unknown high economy in patient treatment with highly biocompatible tooth replacements and fillings. Another advantage lies in the seamless integration of existing practices at the dentist's for fillings or of modeling techniques for the dental technician. In particular, no special training is required since the manner of working of the dentist does not require any fundamental reorientation. Furthermore, the high economy of the method according to the invention is also based on the fact that no great investment in equipment is required. A large part of the work up to now separately carried out by specialists, such as modeling, gnathological customization by means of articulators and the like, can namely be omitted.

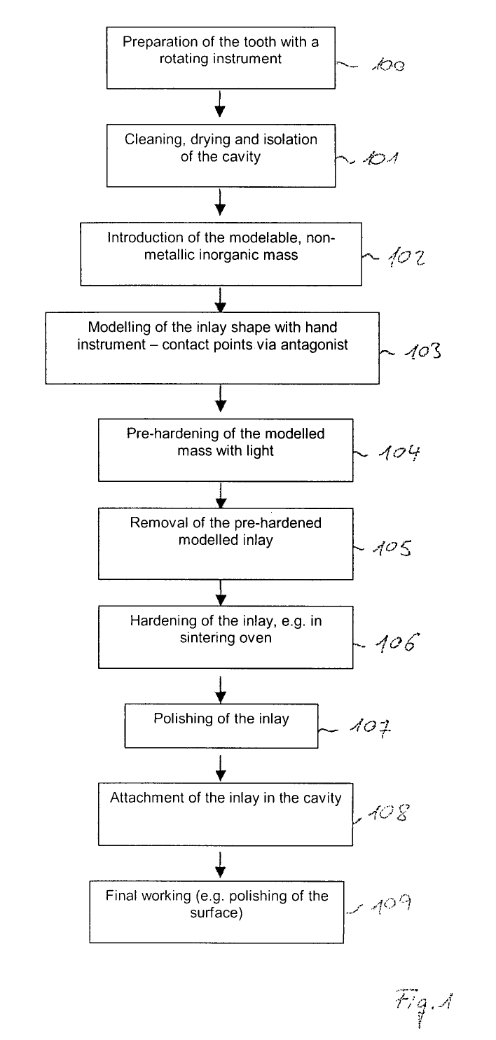

FIG. 1 shows schematically the individual steps in the execution of a first exemplary embodiment of the method according to the invention for the production of a tooth replacement part. In principle, as described above, the solution according to the invention is based on the insight of using a non-metallic, inorganic material which is provided as modelable material in plastic form which on the one hand makes possible the simple production of a not yet completely hardened shaped part, on the other hand—if applicable after appropriate pre-hardening—has a sufficient stability to be able to remove the molding, before the final hardening, from the patient mouth or from a model. The material used for this purpose has correspondingly on the one hand a ceramic component which makes possible the final hardening to a high-strength ceramic part. On the other hand a binder is present which firstly binds the ceramic raw material to a plastic mass, furthermore makes a pre-hardening possible, to ensure that the removal of the modelled shaped part is possible, and which then evaporates upon the sintering of the shaped part.

The method for the production of a tooth replacement part in form of an inlay in accordance with the first variant then occurs in accordance with the following scheme.

In a first step 100, firstly the tooth which is to be provided with a tooth replacement part is treated with a rotating instrument. The use of other methods of removal for the preparation of the tooth would of course also be conceivable. In the following step 101 the cavity is then cleaned, dried and isolated so that it can be used for the production of the tooth replacement part.

A first central point of the method according to the invention is then step 102, in which the modelable, non-metallic inorganic mass is brought into the cavity. In the patient mouth then, in step 103, the inlay form is modeled by means of hand instruments in conventional manner from the plastic mass, whereby the contact points of the inlay form are maintained via the antagonists of the tooth to be provided with the tooth replacement part. Thus, modeling of the shaped part is effected in the same way as tooth fillings, for example of plastic material, are conventionally formed at the dentist's office.

After completion of the modeling of the inlay form the modeled shaped part is then pre-hardened in step 104, which can be effected in particular by irradiation of the material by means of light. The use of other systems which make it possible to provide a certain stability for the mass would also be conceivable. Use of multiple component systems also could particularly be exploited, with which the mass manifests a higher stability with increasing time.

The inlay which is in this way pre-hardened and modeled is then in step 105 taken from the patient mouth, whereby the stability of the material is now so high that the shaped part is not damaged or deformed upon removal. In the following step 106 the shaped part is then hardened in a classical way, which for example is effected in a sintering oven. In this way a high-strength ceramic replacement part is formed which is then polished in step 107. The inlay is finally attached (step 108) in the cavity of the tooth to be treated. As final processing a polishing can for example be provided for the surface of the replacement part in step 109.

From the above description of the method according to the invention it is apparent that the production of the tooth replacement part can be directly carried through by the dentist in a very simple way. In particular the use of complex machines is not required for the processing of the replacement part, for which reason the method can be carried out extremely economically. If, further, a material is used which in the final sinter step 106 manifests substantially no shrinkage it can be ensured that the replacement part has a very high fitting precision for the tooth cavity.

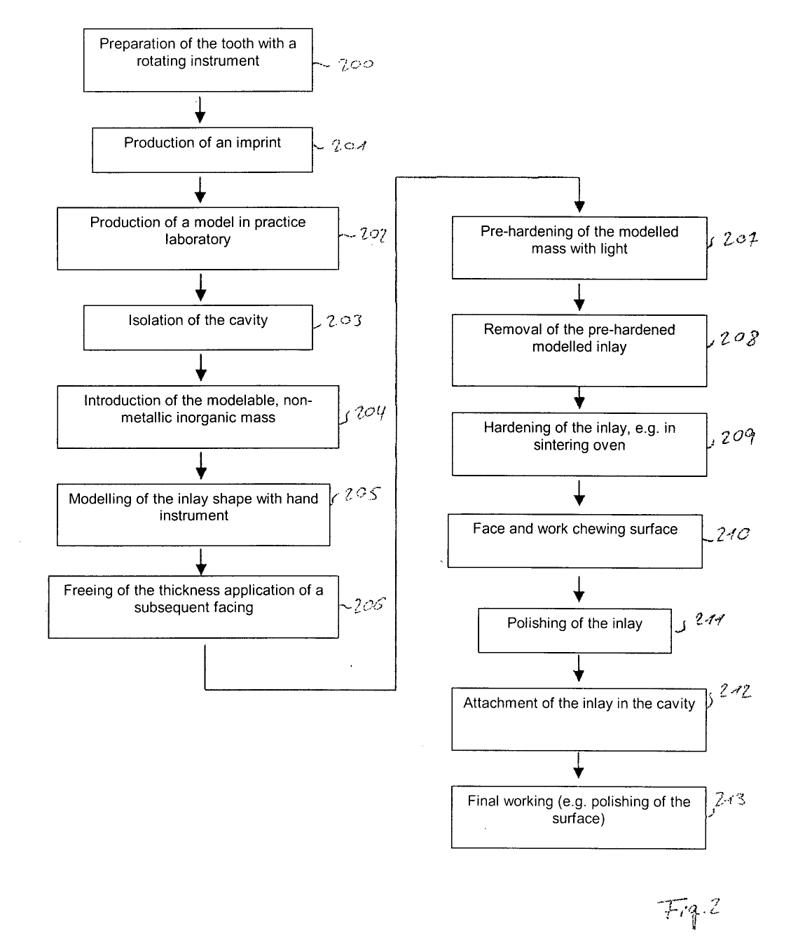

As an alternative to the method just described the possibility of producing the tooth replacement part at the dental technician's also arises. For this purpose a modified method is put to use the steps of which are illustrated in FIG. 2.

In turn the alternative method begins firstly with the step 200, in which the tooth is prepared by material removal with a rotating instrument or otherwise. Now, however, an imprint is taken (step 201) which makes possible the production of a model in the practice laboratory in the following step 202. On the basis of this model, in turn the cavity is isolated (step 203) into which a modelable, non-metallic inorganic mass is then brought, as in the case of the previous method in accordance with FIG. 1 (step 204).

As with the previous method the inlay form is then modeled in step 205 with aid of a hand instrument, whereby in step 206 in particular the freeing of the thickness application of a subsequent facing also can be taken into account. Subsequently the modeled mass is in turn pre-hardened (step 207) and removed from the model in step 208. To make this removal easier—also with the method according to FIG. 1—the shaped part may be provided with an assistance element in form of a pin, projection or stud which is removed again at a later time. Also removal with aid of a tool, e.g. a threaded tap, would be conceivable, whereby the hole possibly formed is then filled again before the final hardening of the shaped part.

For the completion of the ceramic replacement part the modeled inlay then is hardened in step 209, whereby with use of a suitable model material it would also be conceivable to harden the tooth replacement part directly in the model. Then, in step 210, the chewing surface is faced and worked, upon which the process of polishing the inlay (step 211) follows. The inlay is finally in turn attached in the cavity of the tooth of the patient in step 212. A final processing (step 213) can follow this.

This alternative method thus makes it possible to use additional facings. Although production in a dental laboratory is required in turn, the effort for the processing of the material is however considerably lower in comparison with materials used till now.

Analogously to the above described exemplary inlay production, there can be produced in similar manner, with the modelable non-metallic inorganic mass according to the invention, at the dentist's, in the practice laboratory, in the dental laboratory, also individual crowns for the side tooth and molar tooth area. Also more extensive work would be conceivable.

Seen overall the possibility is therefore provided by the invention of manufacturing highly compatible and exactly fitting tooth replacement parts in a simple and in particular economic manner. The use of expensive machines for the processing of the material can be foregone. For the dentist, there opens up in this way the possibility of producing in a simple way tooth replacement parts which satisfy most exacting requirements.

1. Method for the production of tooth restorations or tooth replacement parts from a non-metallic, inorganic material, comprising the steps of
a) modeling a modelable material in plastic form in the mouth of a patient or with use of a model to form a shaped part;
b) removing the shaped part from the mouth of the patient or from the model; and
c) hardening the shaped part to a ceramic tooth restoration or to a tooth replacement part.

2. The method of claim 1, comprising pre-hardening the modeled shaped part before removal from the mouth of the patient or from the model.

3. The method of claim 2, comprising pre-hardening the shaped part by irradiating the shaped part.

4. The method of claim 2, wherein the material contains a component through the effect of which the material has a higher stability with increasing time.

5. The method of claim 1, wherein the modelable material does not shrink during the hardening step.

6. The method of claim 1, wherein the modelable material shrinks by a desired amount during the hardening.

7. The method of claim 1, removing comprising the shaped part from the mouth of the patient or from the model with the aid of an assisting element.

8. The method of claim 7, wherein,
the assisting element is a pin or a projection provided on the shaped part.

9. Material for the production of tooth restorations or tooth replacement parts, comprising
a ceramic component which makes possible a hardening of the material to a ceramic part, and
a binder which places the material in a plasticized state.

10. Material of claim 9, wherein the binder makes possible a pre-hardening of a shaped part formed of the material.
